(19) United States
(12) Patent Application Publication
(10) Pub. No.: US 2009/0022854 A1
(43) Pub. Date: Jan. 22, 2009

(54) COMPOSITIONS AND METHOD OF PREPARATION OF METAL ACETATE SOLUTIONS FREE OF SYNTHETIC CHEMICALS

(76) Inventor: Arup Sen, Gainesville, FL (US)

Correspondence Address: Martin L. McGregor, 26415 Oak Ridge Drive, Spring, TX, 77380, US

(21) Appl. No.: 12/168,558

(22) Filed: Jul. 7, 2008

Related U.S. Application Data
(63) Continuation-in-part of application No. 12/043,132, filed on Mar. 6, 2008, now abandoned.
(60) Provisional application No. 60/905,142, filed on Mar. 6, 2007.
(60) Provisional application No. 60/958,649, filed on Jul. 6, 2007.

(51) Int. Cl. A23L 1/304

(52) U.S. Cl. 426/74; 426/648; 426/429

(57) ABSTRACT

A method and compositions of matter that comprise a solution of a metal such as calcium, magnesium, potassium or zinc derived from coral or other natural source by treatment with an edible acetic free of synthetic chemicals are disclosed. Alternatively, a process for providing a soluble source of metal ions free of synthetic chemicals but suitable for providing solutions of accurately predicted concentration is described. For example, the method for preparing a synthetic chemical free solution of dissolved calcium comprises the steps of treating coral with an edible acetic until the production of bubbles ends and then removing any residual solids to produce a clear solution.

### RELATED APPLICATIONS

This application is a continuation in part of U.S. patent application Ser. No. 12/043,132 filed Mar. 6, 2008 which is a Continuation in part of Provisional Patent Application Ser. No. 60/905,142 filed Mar. 6, 2007. This application is also a continuation in part of U.S. Provisional Application 60/958,649 filed Jul. 6, 2007.

### FIELD OF THE INVENTION

The invention relates to novel methods for preparing a highly water soluble metal acetate solutions from coral and other natural materials, containing calcium, magnesium, potassium, and zinc.

### BACKGROUND OF THE INVENTION

One of the most common form of calcium storage in nature is the carbonate salt that is found in shells, corals, many skeletal structures of lower life forms and in the soil, for example as limestone deposits. In mammals, including humans, the primary mineral component of the skeletal structure is hydroxyapatite-phosphate salts of calcium that form nearly 70% of the bone mass and provides it with the unique mechanical properties.

Maintenance of the mineral content is essential for proper bone health. Loss of the mineral material such as in conditions like osteoporosis is a major disease that affects billions of people in the world. Bone fractures and remedial surgeries used to repair them are associated with significant risk of morbidity and mortality, especially in older people. There is, therefore, a great need to supply calcium to the body in order to support the body's ability to maintain the calcium mineral mass in bone.

Considerable work has been carried out over the past several decades in preparing dietary supplements that contain calcium in their “bioavailable” form—namely, salts of calcium that can be absorbed from the gastrointestinal tract and utilized by the body's metabolic machinery that replenishes calcium salts in the bony tissues. While the roles of vitamins such as vitamin D, other mineral ions such as Magnesium, and hormones such as estrogen have been recognized to have important beneficial effects on the absorption and utilization of dietary calcium, the inherent bioavailability of the actual calcium salt present in the diet is a critical factor. Solubility of the calcium salt in water-based media is likely to be an important determinant in the bioavailability of this essential mineral. Calcium derived from coral is especially desired by persons that wish to avoid using synthetic chemicals in their diets.

Magnesium is a significant mineral that is found in the human body, the majority being found in the musculoskeletal tissues (bone and muscle). Biochemical literature reports indicate that magnesium plays a role in several enzymatic reactions that are critical to normal functioning of cells, including those involved in the synthesis of proteins and energy metabolism. There is a growing realization that dietary intake of bioavailable magnesium is beneficial to human health. Although the exact mechanisms of absorption of magnesium form the gastrointestinal tract are unknown, most of dietary magnesium is believed to be absorbed in the small intestine.

Green vegetables such as spinach, legumes, nuts, whole grains and vegetables are considered reasonable sources of dietary magnesium. Refined grain and products made from them are markedly lower in magnesium. The Recommended Dietary Allowances (RDA) for magnesium is between 80 mg/day to about 400 mg/day for children to adults with differences between the levels for male versus female. The National Institutes of Health Clinical Center's Office of Dietary Supplements provides information regarding magnesium (http://dietary-supplements.info.nih.gov/factsheets/magnesium). Also see Shils, M E (1984) Magnesium. Nutrition Reviews' Present Knowledge in Nutrition, The Nutrition Foundation, Washington D.C. (pp 423-427).

Magnesium supplements are potentially beneficial and/or necessary in certain conditions that reduce absorption or increase excretion through the kidney. Certain antibiotics and cancer drugs, Crohn's Disease patients and older individuals may have lower absorption of dietary magnesium. Diuretics, individuals with poorly controlled diabetes, patients suffering from alcoholism and individuals with chronically low blood levels of magnesium and calcium are also candidates for dietary magnesium supplementation. Recent reports also indicate that magnesium may facilitate the absorption of dietary calcium.

Preparations of substantially pure salts of calcium, magnesium potassium, zinc and other metals that can be readily dissolved in water will, therefore, are desirable and necessary in formulating effective dietary supplements with desired quantities of calcium, magnesium or other salts. In general, the ease of dissolution in water is associated with bioavailability of most minerals consumed in the diet. High water solubility also is useful in preparing a concentrate that is clear and can be added to beverages without compromising the appearance.

Potassium, zinc and traces of other metal salts are also necessary minerals for a healthy diet, heretofore highly soluble all natural sources have not been available. The naturally occurring sources of these materials such as sea water and sea salt contain many anions that may limit the solubility various salts and make control of dosages problematic.

There also is a growing consumer trend for dietary consumption of preparations that are produced from natural sources and do not use synthetic chemicals wherein traces might be left behind in the final product.

Heretofore producers of calcium products from coral have not been successful in producing clear solutions of calcium without using synthetic chemical reagents. The same difficulties are experienced for other salts from natural materials. The present invention provides a method and products that enable formulation of highly soluble mineral supplements for supplementing the diet, re-mineralizing desalinated sea water and the like.

### SUMMARY OF THE INVENTION

The invention provides a composition of matter, free of synthetic chemicals, that comprises a solution of a metal selected from the group consisting of calcium, magnesium, potassium or zinc derived from a naturally occurring carbonate source of the selected metal by treatment of the naturally occurring carbonate source with an edible naturally occurring source of acetic acid. Preferably the naturally occurring carbonate source is selected from the group consisting of coral, limestone, and marble. The especially preferred source is coral. Especially preferred acetic acid sources are the products of ethanol fermentation.

The invention also provides a method for preparing a synthetic chemical free solution of dissolved a metal salt comprising the steps of treating a naturally occurring carbonate source of a metal selected form the group consisting of calcium, magnesium, potassium and naturally produced food grade acetic acid until the production of bubbles ends and then removing any residual solids to produce a clear solution. In a preferred method the naturally occurring carbonate source is selected from the group consisting of coral, limestone, and marble. The invention also provides novel products produced by the method.

In a preferred embodiment this invention describes a process to create a preparation of a water soluble form of magnesium using food grade acetic acid from vinegar or other natural sources from a metal carbonate that is found in nature. The practice of this invention results in the creation of a novel product by process composition that does not commonly occur in nature but is considerably more water soluble than the naturally occurring carbonates that maybe of limited solubility or even virtually insoluble. The water soluble naturally derived mineral salts are a novel edible formulation that may serve as a more effective bioavailable source of calcium, magnesium, potassium, zinc or other metals.

### DETAILED DESCRIPTION OF THE INVENTION

### Calcium

This example describes the invention in terms of a process to create a preparation of water soluble form of calcium using acetic acid from calcium carbonate present in corals. The practice of this invention results in the creation of a novel calcium composition that does not commonly occur in nature but is considerably more water soluble than naturally occurring calcium carbonate. This water soluble calcium salt is a novel edible formulation that may serve as a more effective bioavailable source of calcium for the support of bone health. The solution is free of synthetic chemicals and thus may be included in products that are labeled as “organic.”

In a typical experiment, food grade coral powder (amorphous white microgranules) and comprised primarily (>90%) of calcium carbonate is used as a source of natural calcium. Coral powder is gradually added to an acetic acid solution at room temperature with gentle stirring and caution is taken to avoid the bubbling carbon dioxide from causing overflow of the liquid from the container. The acetic acid can be a reagent grade chemical, distilled white vinegar or organic vinegar that are commonly available as food grade materials. The pH of the solution is monitored using a pH meter or pH paper. Addition of granules is stopped when the pH approaches between about 6.0-7.0 or visibly detectable sediment of coral powder is observed even after stirring. The mixture is allowed to sit for about 1 hr with occasional stirring until the bubbling stops. Any visible sediment is allowed to settle to the bottom of the container and the clear fluid is decanted carefully avoiding the transfer of any sediment into the clear solution. Reagent grade ammonium hydroxide is then added to bring the pH of the solution to approximately between 8.0 and 9.0. The solution turns cloudy and fresh sediment is formed. The sediment is allowed to settle, the clear fluid is decanted and the sediment is collected. The wet sediment is dried under vacuum, dissolved in water and the material is dried again. The process may be repeated multiple times in order to remove any volatile materials such as acetic acid, ammonia and carbon dioxide with attendant reduction in an odor that is not present in the original coral powder.

The solubility of the final dried calcium is estimated and only preparations that completely dissolve in water at or above approximately 0.5 g/liter is accepted as the final water soluble calcium formulation. It is also desirable to confirm that the pH of the solution with the dissolved soluble calcium prepared as above is above 7.0. The calcium-enriched filtrate produced as above may be concentrated by freeze drying or drying the liquid under vacuum in an evaporator concentrator until desired concentration of calcium is attained or to an essentially dry powder.

### Magnesium

In a typical experiment, a naturally occurring magnesium carbonate, which may contain other metal ions such as calcium excavated from a mine or quarry and milled to a fine powder is used as the source of magnesium. The powder is gradually added to an acetic acid solution at room temperature with gentle stirring and caution is taken to avoid the bubbling caused by carbon dioxide evolution from causing overflow of the liquid from the container. The acetic acid can be a reagent grade chemical, distilled white vinegar or organic vinegar that are commonly available as food grade materials, so long as it is not synthetically produced. The pH of the solution is monitored using a pH meter or pH paper. Addition of granules is stopped when the pH approaches between about 6.0-7.0 or visibly detectable sediment of the magnesium powder is observed even after stirring. The mixture is allowed to sit for about 1 hr with occasional stirring until the bubbling stops. Any visible sediment is allowed to settle to the bottom of the container and the clear fluid is decanted carefully avoiding the transfer of any sediment into the clear solution. The solution is allowed to settle, the clear fluid is decanted and dried into a solid powder. The process may be repeated multiple times in order to remove any volatile materials such as acetic acid, ammonia and carbon dioxide with attendant reduction in an odor that is not present in the original powder.

The solubility of the final dried magnesium salt is estimated and only preparations that completely dissolve in water at or above approximately 5 gm/liter is accepted as the final water soluble magnesium formulation. It is also desirable to confirm that the pH of the solution with the dissolved soluble magnesium prepared as above is above 7.0.

As used here in synthetic refers to a reaction carried out by human intervention and design. For example, acetic acid produced by a not genetically engineered micro-organism converting ethanol to acetic acid is not a synthetic process, even if the micro-organism, and feed stock are brought together by human action. But a catalytic oxidation of ethanol to acetic acid is considered synthetic, even if the catalyst used were a naturally occurring enzyme isolated from a micro-organism.

### Application of Process to Various Sources of Minerals:

In one application of the process, eight different sources of Calcium Carbonate found in nature were subjected to the process substantially as follows. In a solution containing 10% by volume of glacial acetic acid (EMD Chemicals) or food grade acetic acid (Eastman Chemicals) diluted in water or distilled white vinegar purchased commercially (National Vinegar Company) at 10% acidity was used and powdered preparation of test Calcium Carbonate gradually added with stirring. Addition of the powder was stopped when a theoretically estimated amount of Calcium Carbonate (based on Certificate of Analysis provided by the respective manufacturer of the test Calcium Carbonate) approached a weight ratio of about 1 unit of Calcium Carbonate to about 1.2 units of acetic acid. The stirring was continued for an additional hour or until the visible cessation of carbon dioxide gas release and the pH of the final solution at about between 5.7 to about 6.5. After settling, the clear liquid was decanted and centrifuged, if necessary, to obtain a clear liquid. The clear liquid was dried by freeze drying or in an evaporative concentrator at a temperature of between 40 C to about 80 C or in a convection oven at a temperature of about between 60 C and 80 C until the material was essentially dry. The final preparations were tested for Calcium content by one of several contract laboratories that routinely conduct such mineral analyses in water and/or food products (Standard Methods for Determination of Organic Compounds in Drinking Water, EPA-600/4-79-020 and Test Methods for Evaluation of Solid Waste, Physical/Chemical Methods [SW486] Third Edition). Results (average) of several typical experiments are presented in the Table below:

| | Elemental Calcium |
|---|---|
| Starting Material | (mg/Kg solid)* |
| Coral Calcium powder #1 | 260,000 |
| Coral Calcium powder #2 | 260,000 |
| Coral Calcium powder #3 | 250,000 |
| Marble type Calcium** | 230,000 |
| Oyster Shell Calcium | 250,000 |
| Organic Egg Shell*** | 230,000 |
| Reference Standard Preparation | 250,000 |

*theoretical value for anhydrous Calcium Acetate is about 253,000 mg/Kg solid
**contains approximately 12,000 mg/Kg elemental Magnesium (marble Calcium materials are known to contain Magnesium Carbonate and/or Oxide)
***egg shells were harvested from organic eggs after discarding the white and the yolk; crushed shells were extensively washed with hot (about 90 C.) water followed by methanol and dried prior to processing as described above; contained about 2,100 mg/Kg Magnesium and an undetermined amount of an iron-containing material (egg shells are reported to contain the pigment porphyrin that binds iron)

### Application of the Process to Different Minerals and Products Produced Thereby:

The process as described above was used with different minerals (in their Carbonate, Oxide and Hydroxide forms) where the amount of the starting mineral powder was varied to obtain essentially the following ratios—
for Magnesium, about 1 unit weight of elemental Magnesium with between about 4.5 to about 5.2 unit weight of acetic acid;
for Potassium, about 1 unit weight of elemental Potassium to between about 1.25 to about 1.6 unit weight of acetic acid;
for Zinc, about 1 unit weight of elemental Zinc to between about 1.8 to about 2.2 unit weight of acetic acid and
for Calcium, about 1 unit weight of elemental Calcium to between about 2.8 to about 3.2 unit weight of acetic acid.

In all cases, the final preparation demonstrated a high degree of water solubility as tested in standard drinking water (city tap or bottled) at or above 10% weight by volume. In each case, the analysis of elemental mineral in the final dried material was substantially the same as theoretically predicted for the corresponding acetate salt as follows: for Magnesium, about 15%, for Potassium, about 38%, for Zinc, about 29% and for Calcium about 25%. The results enable one skilled in the art to produce essentially homogeneous preparations of these minerals and potentially others in the group in highly water soluble forms.

Uniform Blends of Minerals with Predetermined Ratios of Minerals:

A preferred application of this invention is the enablement to produce uniform mixtures or blends of various minerals with reported benefits for human and animal health. Customarily, different salts of the minerals are blended together to achieve desired levels of the minerals in different food, dairy, beverage and water products by most manufacturers. The clear liquids obtained following the conversion process essentially as described above can be readily mixed to obtain liquid mixes containing pre-decided minerals chosen by one. The mixing formula may be readily developed based on measuring the mineral content in the respective liquids produced by the process described in this invention for a mineral of interest. In a series of experiments blends of Calcium, Magnesium and Potassium at different ratios were produced by first mixing the liquids, followed by drying by one of the methods described herein. The final dry powders were analyzed by standard methods as above and elemental content of each mineral determined. In each blend tested (n=6), the amounts of the minerals were within ±7% of the expected values. Some of the materials are hygroscopic and accordingly, absorb moisture that results in minor alterations of elemental minerals from values predicted based on anhydrous contents. The blends retain water solubility and are generally readily soluble at up to 20% weight/volume in drinking water (city tap or bottled). These mineral and mineral blend concentrates are novel ready for use compositions that are built on the same anion (acetate) and accordingly, essentially eliminate the possibility of chemical reactions between source materials for these minerals that are often used by manufacturers.

### Manufacturing/Large Scale Production:

Utilizing the principle embodied in the process described above, and with reasonable modifications that meet logistics needs for large scale manufacturing for commercial use of the highly water soluble minerals of this invention. One example of such a large scale manufacturing of a mineral is described below.

In a 500 gallon tank, 400 gallons of drinking water was placed and between about 300 Kg to about 400 Kg coral calcium carbonate powder was added with stirring to produce a slurry. Concentrated food grade acetic acid was added gradually over a period of about 10 hr to about 30 hr with continued mixing. Adjustments of the rate of addition of the acid were made as needed to accommodate the production of carbon dioxide gas/froth during the process. Sufficient acid was added to achieve a ratio of approximately 1 unit weight of Calcium to about 3.0 unit weight of acetic acid. Stirring was continued for between about 12 hr to about 24 hr following the completion of the acid. Insoluble material was allowed to settle for between about 24 hr to about 72 hr. Clear liquid was withdrawn by a pump and dried in a spray dryer. The dry material was analyzed as before and was demonstrated to be essentially the same as that produced by the laboratory scale procedure described above with respect to Calcium content, solubility in drinking water, appearance and levels of trace minerals contained in the original coral Calcium Carbonate. One skilled in the art will be readily able to develop and practice the process described in this invention for the production of these minerals for use for human health benefit.

What is claimed is:

1. A composition of matter, free of synthetic chemicals, that comprises a solution of at least one metal selected from the group consisting of calcium, magnesium, potassium or zinc derived from a naturally occurring carbonate source of the selected metal by treatment of the naturally occurring carbonate source with an edible naturally derived acetic acid.

2. A composition according to claim 1 wherein the naturally occurring carbonate source is selected from the group consisting of coral, limestone, and marble.

3. A composition according to claim 1 wherein the metal selected is calcium.

4. A composition according to claim 1 wherein the acetic acid is food grade acetic acid.

5. A composition according to claim 1 wherein the acetic acid is acetic acid derived from a vinegar.

6. A composition according to claim 1 wherein the metal selected is magnesium.

7. A composition according to claim 6 wherein the acetic acid is food grade acetic acid.

8. A composition according to claim 6 wherein the acetic acid is acetic acid derived from a vinegar.

9. A composition according to claim 1 wherein the metal selected is potassium.

10. A composition according to claim 9 wherein the acetic acid is food grade acetic acid.

11. A composition according to claim 9 wherein the acetic acid is acetic acid derived from a vinegar.

12. A composition according to claim 1 wherein the metal selected is zinc.

13. A composition according to claim 9 wherein the acetic acid is food grade acetic acid.

14. A composition according to claim 9 wherein the acetic acid is acetic acid derived from a vinegar.

15. A method for preparing a synthetic chemical free solution of dissolved a metal salt comprising the steps of treating a naturally occurring carbonate source of a metal selected form the group consisting of calcium, magnesium, potassium and zinc with an edible naturally derived acetic acid until the production of bubbles ends and then removing any residual solids to produce a clear solution.

16. A method according to claim 9 wherein the naturally occurring carbonate source is selected from the group consisting of coral, limestone, and marble.

17. A method according to claim 9 wherein the metal selected is calcium.

18. A method according to claim 9 wherein the acetic acid is food grade acetic acid.

19. A method according to claim 9 wherein the acetic acid is acetic acid derived from a vinegar.

20. A method according to claim 9 wherein the metal selected is magnesium.

21. A method according to claim 9 wherein the acetic acid is food grade acetic acid.

22. A method according to claim 9 wherein the acetic acid is acetic acid derived from a vinegar.

23. A method according to claim 9 wherein the metal selected is potassium.

24. A method according to claim 9 wherein the acetic acid is food grade acetic acid.

25. A method according to claim 9 wherein the acetic acid is acetic acid derived from a vinegar.

26. A method according to claim 9 wherein the metal selected is zinc.

27. A method according to claim 9 wherein the acetic acid is food grade acetic acid.

28. A method according to claim 9 wherein the acetic acid is acetic acid derived from a vinegar.

29. A solution of calcium acetate prepared according to claim 15.

30. A solution of magnesium acetate prepared according to claim 15.

31. A solution of potassium acetate prepared according to claim 15.

32. A solution of zinc acetate prepared according to claim 15.

33. A composition according to claim 1 that comprises two metals.

34. A composition according to claim 1 that comprises three metals.

35. A composition according to claim 1 that comprises four metals.

36. A dietary supplement comprising a composition according to claim 33.

37. A dietary supplement comprising a composition according to claim 34.

38. A dietary supplement comprising a composition according to claim 35.
